(19) United States
(12) Patent Application Publication
(10) Pub. No.: US 2006/0258225 A1
(43) Pub. Date: Nov. 16, 2006

(54) ADAPTER FOR HIGH FREQUENCY SIGNAL TRANSMISSION

(75) Inventor: Chin-Teng Hsu, Yungkang City (TW)

Correspondence Address: NIKOLAI & MERSEREAU, P.A., 900 SECOND AVENUE SOUTH, SUITE 820, MINNEAPOLIS, MN, 55402, US

(73) Assignee: Lih Yeu Seng Industries Co., Ltd., Yungkang City (TW)

(21) Appl. No.: 11/306,834

(22) Filed: Jan. 12, 2006

(30) Foreign Application Priority Data
May 10, 2005 (TW) 094207467
Nov. 30, 2005 (TW) 094220867

(51) Int. Cl. H01R 33/00

(52) U.S. Cl. 439/638

(57) ABSTRACT

An adapter for high frequency signal transmission includes in one embodiment a cylinder having a staged bore; a central transmission rod including an intermediate toothed ring, first and second ports at both ends, and a tapered portion formed around the first port; a first Teflon block fitted in one portion of the bore; and a second Teflon block fitted in another portion of the bore and including a metal ring having a toothed member secured onto the second Teflon block. A vacuum is created by the first Teflon block, the second Teflon block, the toothed ring, and the bore. Both the first and second ports are male ports, both the first and second ports are female ports, the first port is a female port and the second port is a male port, or the first port is a male port and the second port is a female port.

### BACKGROUND OF THE INVENTION

1. Field of Invention

The present invention relates to adapters and more particularly to a connector shaped adapter for high frequency signal transmission with improved characteristics.

2. Related Art

A conventional adapter 10 interconnected, for example, a connector 70 of a testing instrument and a connector 70 of a device (e.g., mobile phone) to be tested is shown in FIGS. 1 and 2. Within the cylindrical adapter 10 there are provided a central transmission rod 20 and a plastic ring 30 formed between the transmission rod 20 and an inner surface of the adapter 10. The transmission rod 20 is thus fastened by the ring 30. However, its manufacturing process is time consuming and cost ineffective.

Another conventional adapter 40 of such type is shown in FIG. 3. A front and rear cylindrical Teflon sections 50 are formed within an inner surface of the adapter 40. A central transmission rod 60 passes through the Teflon sections 50 and is thus fastened by the Teflon sections 50. However, the insulative Teflon sections 50 may absorb signals transmitted along the transmission rod 60, resulting in a decrease of the transmission efficiency. For increasing the transmission efficiency (e.g. wireless transmission), it is possible of increasing power. However, power increase may threaten health of nearby people due to electromagnetic radiation. Thus, a need for improvement exists.

### SUMMARY OF THE INVENTION

It is therefore an object of the present invention to provide an adapter comprising a body including a first bore provided at one end, an intermediate second bore having a diameter larger than that of the first bore, a third bore provided at the other end and having a diameter larger than that of the second bore, a first shoulder provided between the first and the second bores, and a second shoulder provided between the second and the third bores; a first Teflon block adapted to be received in the first bore; a second Teflon block adapted to be received in the third bore and including a metal ring having a toothed member secured onto one portion of the second Teflon block; a central transmission rod including an intermediate toothed ring provided on its outer surface, a first port provided at one end and inserted through said first Teflon block until said first Teflon block being against the toothed ring, a second port provided at the other end and inserted through said second Teflon block until a portion of the toothed ring being within the second Teflon block, and a tapered protrusion formed around the first port and protruding from the first Teflon block, with said transmission rod being placed into the body so that there being spaces around the tapered protrusion and between the first and second Teflon blocks; whereby the contact area of the body and the first and second Teflon blocks is decreased and air is filled with said spaces so as to create air insulation.

The above and other objects, features and advantages of the present invention will become apparent from the following detailed description taken with the accompanying drawings.

### BRIEF DESCRIPTION OF THE DRAWINGS

FIG. 1 is a broken-away perspective view of a conventional adapter;

FIG. 2 is a sectional view showing the adapter in FIG. 1 being interconnected two connectors;

FIG. 3 is a broken-away perspective view of another conventional adapter;

FIG. 4 is an exploded view of a first preferred embodiment of an adapter according to the invention;

FIG. 5 is a broken-away perspective view of the adapter in FIG. 4;

FIG. 6 is a broken-away perspective view of the adapter in FIG. 4 being connected to a connector of a testing instrument;

FIG. 7 is a view similar to FIG. 5 where both the second Teflon block and the metal ring are slightly altered in another configuration;

FIG. 8 is a perspective view of the adapter in FIG. 4 having its appearance being altered to resemble a connector for computer's motherboard;

FIG. 9 is a view similar to FIG. 8 where the adapter having its appearance being altered to resemble a transverse connector;

FIG. 10 is a view similar to FIG. 8 where the adapter having its appearance being altered to resemble an L-shaped connector;

FIG. 11 is a view similar to FIG. 8 where the adapter having its appearance being altered to resemble an upright connector;

FIG. 12 is an exploded view of a second preferred embodiment of an adapter according to the invention;

FIG. 13 is a broken-away perspective view of the adapter in FIG. 12;

FIGS. 14 and 15 are sectional views showing a first configuration of the adapter in FIG. 12;

FIG. 16 is a sectional view showing a second configuration of the adapter in FIG. 12;

FIG. 17 is a sectional view showing a third configuration of the adapter in FIG. 12; and

FIG. 18 is a perspective view of a transmission rod according to the preferred embodiment of the present invention.

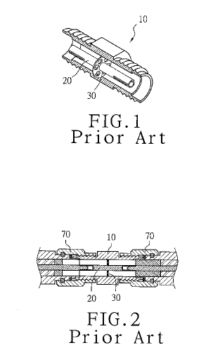

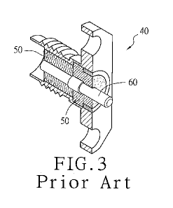

### DETAILED DESCRIPTION OF THE INVENTION

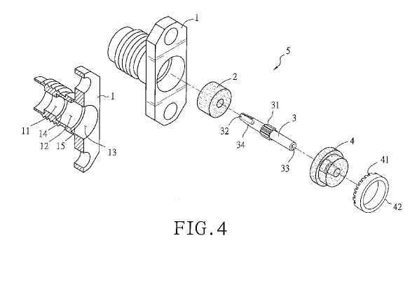

Referring to FIGS. 4 to 11, an adapter 5 for high frequency signal transmission in accordance with a first preferred embodiment of the invention is illustrated. As shown in FIG. 4 specifically, the adapter 5 comprises a body 1 having a hollow cylinder, a first Teflon block 2, a central transmission rod 3, and a second Teflon block 4. Within the cylinder of the body 1 there are provided a first bore 11, a second bore 12 having a diameter larger than that of the first bore 11, a third bore 13 having a diameter larger than that of the second bore 12, a first shoulder 14 between the first and the second bores 11 and 12, and a second shoulder 15 between the second and the third bores 12 and 13. The first Teflon block 2 is fitted with the second bore 12 and has a length shorter than that of the second bore 12.

The transmission rod 3 comprises an intermediate toothed ring 31 on its outer surface, a female port 32 at one end, and a male port 33 at the other end. Note that the transmission rod 3 may have two male ports at both ends, two female ports at both ends, or a female and male ports. The second Teflon block 4 is fitted with the third bore 13 and includes a metal ring 41 having a toothed section 42 on one edge adjacent the second Teflon block 4.

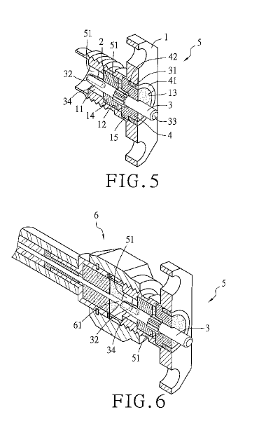

As shown in FIG. 5 specifically, in assembly the first Teflon block 2 is inserted into the second bore 12 from the female port 32 until the first Teflon block 2 is against the toothed ring 31. The protrusion of the transmission rod 3 from the first Teflon block 2 forms a tapered protrusion 34. The male portion 33 of the transmission rod 3 is inserted through the second Teflon block 4 until most portions of the toothed ring 31 is within the second Teflon block 4. Finally, the transmission rod 3 with the first and second Teflon blocks 2 and 4 is snugly inserted into the body 1 until the first Teflon block 2 is stopped by the first shoulder 14 and set within the second bore 12, the second Teflon block 4 is stopped by the second shoulder 15 and set within the third bore 13, and the tapered protrusion 34 is disposed in the first bore 11. The metal ring 41 is set into an annular gap between the second Teflon block 4 and an inner surface of the third bore 13 with the toothed member 42 secured onto the second Teflon block 4 for enhancing friction so as to prevent the first and second Teflon blocks 2 and 4 and the transmission rod 3 from rotating in the body 1. Spaces 51 filled with air are respectively created in the first bore 1I1 and between the first and second Teflon blocks 2 and 4 to be air insulation.

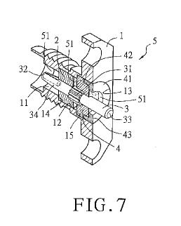

As shown in FIG. 6 specifically, the adapter 5 is connected to a connector 6 of a testing instrument (not shown) in which one end of a central conductor 61 is inserted into the female port 32 for electrical connection. The forming of the space 51 is adapted to decrease a contact area of the transmission rod 3 and the body 1, resulting in an increase of the transmission efficiency.

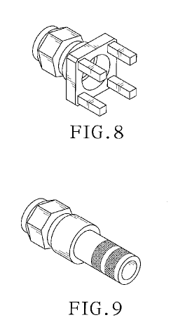

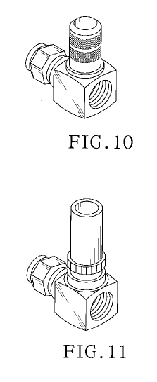

As shown in FIG. 8 specifically, the adapter according to the first preferred embodiment of the invention is modified to resemble a connector for computer's motherboard. As shown in FIG. 9 specifically, the adapter is again modified to resemble a connector of a coaxial cable. As shown in FIG. 10 specifically, the adapter is again modified to resemble an L-shaped coaxial connector. As shown in FIG. 11 specifically, the adapter is again modified to resemble an antenna connector.

As shown in FIG. 7 specifically, both of the second Teflon block 4 and the metal ring 41 are slightly altered in another configuration in which the second Teflon block 4 has its thickness reduced to about half and the metal ring 41 has an inwardly extended rim 43 engaged with the second Teflon block 4 so as to prevent the second Teflon block 4 from loosening and create another space 51 filled with air to be air insulation.

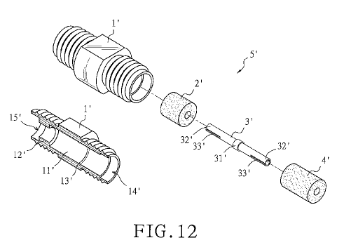

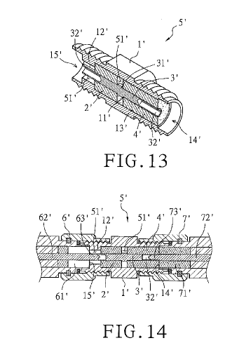

Referring to FIGS. 12 to 18, an adapter 5′ for high frequency signal transmission in accordance with a second preferred embodiment of the invention is illustrated. As shown in FIGS. 12 and 13 specifically, the adapter 5′ comprises a hollow cylindrical body 1′ having an intermediate enlargement. Within the body 1′ there are provided a room 11′, a reduced section 12′ at one side of the room 11′ and an annular flange 13′ at a predetermined section of the room 11′. The adapter 5′ further comprises a first Teflon block 2′, a central transmission rod 3′, and a second Teflon block 4′.

The transmission rod 3′ comprises an intermediate ring 31′. Each end of the transmission rod 3′ is formed into a female port 32′. Two opposite slits 33′ are provided at each of the two female ports 32′. Note that the transmission rod 3′ may have two male ports at both ends, or a female port at the one end and a male port at the other end in other embodiments.

The transmission rod 3′ has its front half inserted through the first Teflon block 2′ and rear half inserted through the second Teflon block 4′ until the first and second Teflon blocks 2′ and 4′ are respectively against the ring 31′ so that the first Teflon block 2′ and the second Teflon block 4′ are spaced by the ring 31′. The transmission rod 3′ is then inserted into the body 1′ until the first Teflon block 2 is against the reduction section 12′ and the second Teflon block 4′ is stuck because of the flange 13′. Thus, a space 51′ filled with air to be air insulation is created in a space defined by the ring 31′, the first Teflon block 2′, the second Teflon block 4′, and an inner wall of the room 11′. Hereby, one of the female port 32′ is level with the second Teflon block 4′ to form a Teflon terminal 14′, and the other of the female port 32′ protrudes from the first Teflon block 2′ to the reduction section 12′ and forms another space 51′ filled with air to be air insulation, so as to form an air terminal 15′. Therefore, the adapter 5′ has two different types of insulative ends.

As shown in FIG. 14 specifically, a connector 6′ of a testing instrument is a terminal 61′ filled with air (i.e., air terminal 61′) and a connector 7′ of a device to be tested is a Teflon terminal 71′. The Teflon terminal 14′ of the adapter 5′ is connected to the Teflon terminal 71′ of the connector 7′ of the device to be tested. A male port 73′ of a transmission rod 72′ of the device to be tested is inserted into one of the female port 32′ of the transmission rod 3′ of the adapter 5′. The air terminal 15′ of the adapter 5′ is connected to the air terminal 61′ of the connector 6′ of the testing instrument. The male port 63′ of the transmission rod 62′ is inserted into the other of female port 32′ of the transmission rod 3′ of the adapter 5′. Both ends of the adapter 5′ are connected to the same insulative members. As an end, test data is more accurate and its result is thus more reliable.

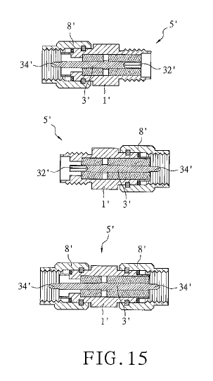

As shown in FIGS. 14 and 15 specifically, a first configuration of the adapter 5′ is shown. Two ends of the transmission rod 3′ of the adapter 5′ may be modified to have two male ports 34′, two female ports 32′, or a male port 34′ at the one end and a female port 32′ at the other end. Also, a connector 8′ is connected to male port 34′ of the adapter 5′. As a result, it is possible of configuring both ends of the adapter 5′ to have different insulative members.

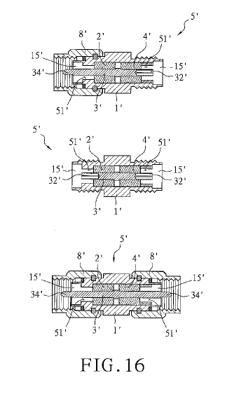

As shown in FIG. 16 specifically, it shows a second configuration of the adapter 5′. Changing thickness of the second Teflon block 4 will configure both ends of the adapter 5′ as air terminals 15′. Both ends of the transmission rod 3′ of the adapter 5′ will form spaces 51′ filled with air to be air insulation. Further, both ends of the transmission rod 3′ of the adapter 5′ may be implemented as two male ports 34′, two female ports 32′, or a male port 34′ at the one end and a female port 32′ at the other end.

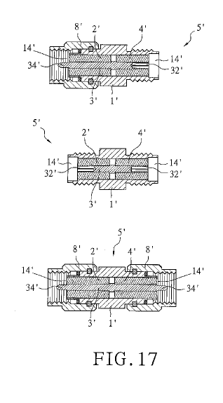

As shown in FIG. 17 specifically, it shows a third configuration of the adapter 5′. Eliminating the reduced section 12′ and the flange 13′, and stuffing the first Teflon block 2′ and the second Teflon block 4′ in the body 1′ will configure both ends of the adapter 5 as Teflon terminals 14. Also, two ends of the transmission rod 3′ of the adapter 5′ may be implemented as two male ports 34′, two female ports 32′, or a male port 34′ at the one end and a female port 32′ at the other end.

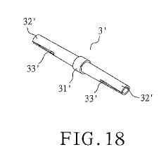

As shown in FIG. 18 specifically, a pair of slits 33 are provided at either female port 32′ of the transmission rod 3′ to facilitate the pressing of the female ports 32′. By pressing the female ports 32′ to be tapered ends, the fastening is more reliable.

While the invention herein disclosed has been described by means of specific embodiments, numerous modifications and variations could be made thereto by those skilled in the art without departing from the scope and spirit of the invention set forth in the claims.

What is claimed is:

1. An adapter comprising:
a body including a first bore provided at one end, an intermediate second bore having a diameter larger than that of the first bore, a third bore provided at the other end and having a diameter larger than that of the second bore, a first shoulder provided between the first and the second bores, and a second shoulder provided between the second and the third bores;
a first Teflon block adapted to be received in the first bore;
a second Teflon block adapted to be received in the third bore and including a metal ring
secured onto one portion of the second Teflon block;
a central transmission rod including an intermediate toothed ring provided on its outer surface, a first port provided at one end and inserted through said first Teflon block until said first Teflon block being against the toothed ring, a second port provided at the other end and inserted through said second Teflon block until a portion of the toothed ring being within the second Teflon block, and a tapered protrusion formed around the first port and protruding from the first Teflon block, with said transmission rod being placed into the body so that there being spaces around the tapered protrusion and between the first and second Teflon blocks;
whereby the contact area of the body and the first and second Teflon blocks is decreased and air is filled with said spaces so as to create air insulation.

2. The adapter of claim 1, wherein the thickness of the second Teflon block is reduced and the metal ring further includes an inwardly extended rim engaged with the second Teflon block so as to create another space for obtaining the increase of air insulation.

3. The adapter of claim 1, wherein the metal ring of the second Teflon block being provided with a toothed member for enhancing friction so as to prevent rotation.

4. The adapter of claim 1, wherein the adapter can be modified to resemble a connector for a computer's motherboard, a transverse connector, an L-shaped connector or upright connector.

5. The adapter of claim 1, wherein the total length of the spaces is about 20-80% of the length of the transmission rod.

6. An adapter comprising:
a hollow body including an intermediate enlargement, a room provided at one end, a reduced section proximate the room, and an annular flange provided at a predetermined section of the room;
a first Teflon block;
a second Teflon block; and
a central transmission rod inserted through both the first and the second Teflon blocks and including an intermediate ring for separating the first Teflon block from the second Teflon block, a first port provided at one end, a second port provided at the other end, and two opposite slits formed at each of the first and the second ports;
said transmission rod being then inserted into the body until said first Teflon block being against the reduction section and the second Teflon block being fastened by the flange, with the second port being level with the second Teflon block to form a Teflon insulative terminal, with the first port protruding from the first Teflon block to the reduction section and forming a space filled with air to be air insulation, so as to form an air insulative terminal.

7. The adapter of claim 1, wherein the first port is one of male port and female port.

8. The adapter of claim 1, wherein the second port is one of male port and female port.

9. The adapter of claim 6, wherein both the first and second ports are female ports and having a pair of slits respectively to facilitate to press of the ports as tapered ends.

10. The adapter of claim 6, wherein the first port is one of male port and female port.

11. The adapter of claim 6, wherein the second port is one of male port and female port.
